(19) United States
(12) Patent Application Publication
(10) Pub. No.: US 2009/0154894 A1
(43) Pub. Date: Jun. 18, 2009

(54) VIDEO SIGNAL PROCESSING APPARATUS

(75) Inventor: Ting-Hsun Wei, Tainan Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/954,504

(22) Filed: Dec. 12, 2007

(51) Int. Cl. H04N 5/91

(52) U.S. Cl. 386/95; 386/E05.001

(57) ABSTRACT

The invention provides video signal processing apparatuses comprising a first multiplexer, a constrained image converter and a second multiplexer. The first multiplexer receives a plurality of high-definition video signals and selectively outputs one of the received high-definition video signals. The constrained image converter converts the high-definition video signal outputted from the first multiplexer into a constrained form to generate a constrained video signal. The second multiplexer receives the high-definition video signal outputted from the first multiplexer and the constrained video signal, and selectively outputs one of them.

### BACKGROUND OF THE INVENTION

1. Field of the Invention

The present invention relates to video signal processing apparatuses, and in particular, to video signal processing apparatuses capable of providing video signals of various formats.

2. Description of the Related Art

Progressive scan is any method of displaying, storing or transmitting video whereby all lines of each frame are drawn in sequence. This is in contrast to the interlaced scan method used in traditional television systems, whereby only the odd lines, and then the even lines, of each frame are drawn.

Digital Video signals are classified into video formats as shown in Table 1 with respect to scanning type and resolution. There are two Standard-Definition (SD) videos and three High-Definition (HD) videos. The two SD videos include 480 i (480 actively interlaced lines) and 480 p (480 progressively scan lines). The three HD videos include 720 p (720 progressively scan lines), 1080 i (1080 actively interlaced lines) and 1080 p (1080 progressively scan lines). The resolutions of 480 i and 480 p are both 720×480 (345,600 pixels per frame). The resolution of 720 p is 1280×720 (921,600 pixels per frame). The resolutions of 1080 i and 1080 p are both 1920×1080 (2073,600 pixels per frame).

TABLE 1

| Video Format | Scanning Type | Resolution |
|---|---|---|
| 480i | Interlaced | 720 × 480 |
| 480p | Progressive | 720 × 480 |
| 720p | Progressive | 1280 × 720 |
| 1080i | Interlaced | 1920 × 1080 |
| 1080p | Progressive | 1920 × 1080 |

Because the display devices may only be capable of displaying videos of some specific video formats, the video signal processing apparatus such as DVD, HD and BD players are asked to process video signals in different video formats and to provide a video signal in appropriate video format according to the specification of display devices. For example, the videos displayed on analog displays limit visual equivalent of no more than 520,000 pixels per frame, so that analog displays cannot display HD videos (1080 i, 1080 p, and 720 p). Thus, video signal processing apparatus capable of providing a video of a proper video format are called for.

### BRIEF SUMMARY OF THE INVENTION

The invention provides video signal processing apparatuses. The video signal processing apparatus comprises a first multiplexer, a constrained image converter and a second multiplexer. The first multiplexer receives a plurality of first video signals at a plurality of input terminals thereof and selectively outputs one of the received first video signals. The constrained image converter converts the first video signal outputted from the first multiplexer into a constrained form to generate a constrained video signal. The second multiplexer receives the first video signal outputted from the first multiplexer and the constrained video signal at a plurality of input terminals thereof, and selectively outputs one of them.

The first video signals received by the first multiplexer may be of a progressive scanning type or of an interlaced scanning type. In some cases, the video formats of the first video signals received by the first multiplexer are 720 p, 1080 p, or 1080 i. Therefore, the second multiplexer may output a video signal of 720 p, 1080 p or 1080 i, or a constrained video signal constrained from a video signal of 720 p, 1080 p or 1080 i.

In some embodiments, the second multiplexer further receives at least one of a plurality of second video signals. The video format of the second video signal may be 480 p, or 480 i. Thus, the second multiplexer can further outputs a video signal of 480 p or 480 i.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates an embodiment of the video signal processing apparatus of the invention;

FIG. 2 illustrates an embodiment of the constrained image converter 102;

FIG. 3 shows formats of various data streams after being scaling down;

FIG. 4 illustrates a video signal processing apparatus according to another embodiment of the invention;

FIG. 5 illustrates the connection between the de-interlacing device and the interlacing device of the invention;

FIG. 6 illustrates a video signal processing apparatus according to another embodiment of the invention;

FIG. 7 illustrates a video signal processing apparatus according to another embodiment of the invention; and

FIG. 8 illustrates a video signal processing apparatus according to another embodiment of the invention.

### DETAILED DESCRIPTION OF THE INVENTION

The following description shows some embodiments carrying out the invention. This description is made for the purpose of illustrating the general principles of the invention and should not be taken in a limiting sense. The scope of the invention is best determined by reference to the appended claims.

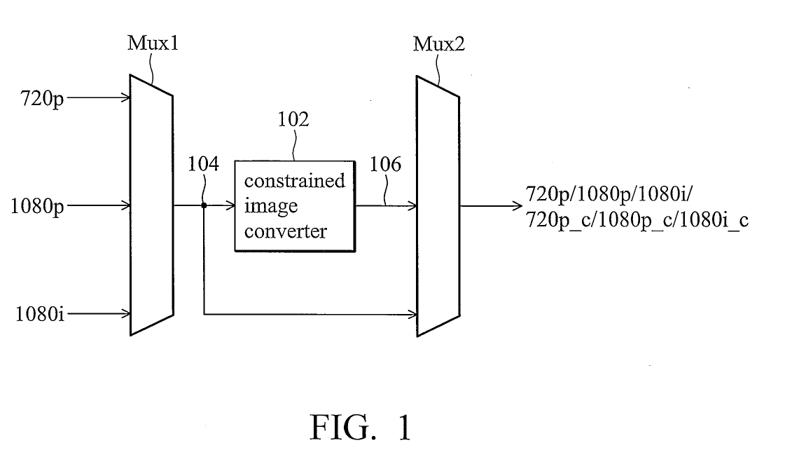

FIG. 1 illustrates an embodiment of the video signal processing apparatus of the invention, comprising a first multiplexer Mux1, a constrained image converter 102, and a second multiplexer Mux2. The first multiplexer Mux1 receives a plurality of video signals (such as high-definition video signals with video formats of 720 p, 1080 p or 1080 i) and selectively outputs one of the received video signals. The constrained image converter 102 converts the video signal outputted from the first multiplexer (104) into a constrained form to generate a constrained video signal (106). The resolution of the constrained video signal 106 is much lower than that of 104. In an embodiment of the invention, the constrained image converter 102 reduced the resolution of input signal (104) and outputs the constrained video signal (106) having the visual equivalent of no more than 520,000 pixels per frame. The second multiplexer Mux2 receives the high-definition video signal outputted from the first multiplexer (104) and the constrained video signal (106), and then selectively outputs one of them (104 or 106). In one embodiment where the video signals inputted to the first multiplexer Mux1 are of 720 p, 1080 i and 1080 p, the second multiplexer Mux2 is capable of outputting a video signal of 720 p, 1080 p or 1080 i, or a constrained video signal generated from a video signal of 720 p, 1080 p or 1080 i (symbolized as 720 p_c, 1080 p_c or 1080 i_c, respectively).

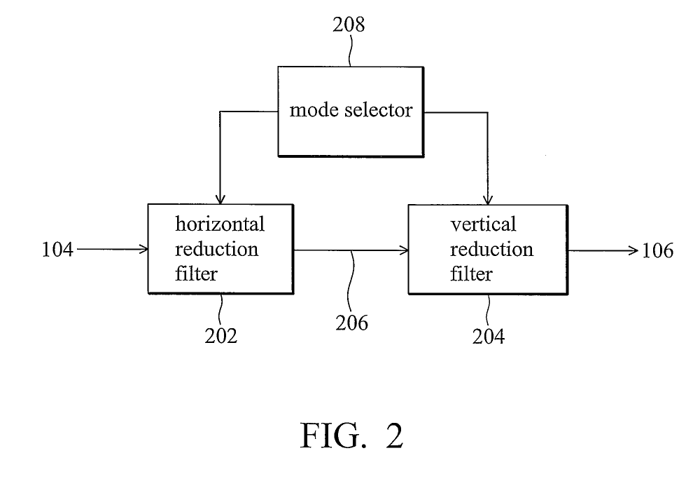

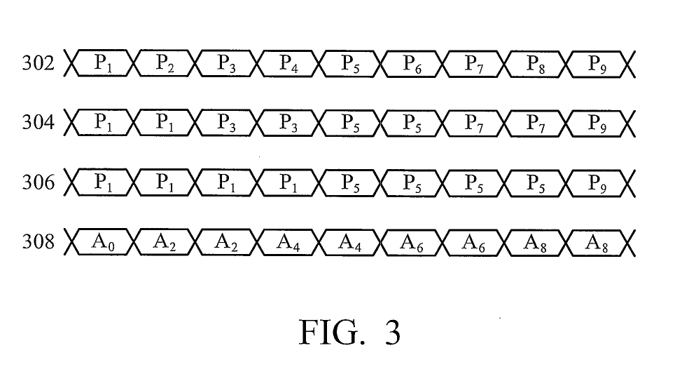

FIG. 2 illustrates an embodiment of the constrained image converter 102, comprising a horizontal reduction filter 202 and a vertical reduction filter 204. The horizontal reduction filter 202 horizontally scales down the high-definition video signal outputted from the first multiplexer (104) to generate a horizontal-scaled video signal 206. The vertical reduction filter 204 vertically scales down the horizontal-scaled video signal 206 to generate the constrained video signal 106. In some embodiments, the horizontal reduction filter 202 duplicates the data of one pixel to its horizontally adjacent pixels to reduce the data quantity of the video signal (to scale down the resolution of the video signal). The duplication is named “doubling”. FIG. 3 shows an original data stream 302 of the video signal. Data stream 304 is generated by doubling the original data stream 302 by 2, in which the video size is horizontally scaled down by 2. Data stream 306 is generated by doubling the original data stream 302 by 4, in which the video size is horizontally scaled down by 4. In some other embodiments, the horizontal reduction filter 202 averages the data of two adjacent pixels and then assigns the averaged datum to the two adjacent pixels to replace their original data. Referring to the data stream 308 shown in FIG. 3, Aₙ=(Pₙ+Pₙ₊₁)/2, and the video size is horizontally scaled down by 2. The vertical reduction filter may vertically scale down the video by the aforementioned similar methods (doubling or averaging).

In the embodiment shown in FIG. 2, the constrained image converter further comprises a mode selector 208 setting scaling factors of the horizontal and vertical reduction filters 202 and 204. For example, when the video signal 104 is of 1080 p (1920×1080) and the mode selector 208 sets the scaling factor of the horizontal reduction filter 202 to be 2 and the scaling factor of the vertical reduction filter 204 to be 2, the resolution of the constrained video signal 106 is 960×540. Alternatively, when the video signal 104 is of 1080 p (1920×1080), and the mode selector 208 sets the scaling factor of the horizontal reduction filter to be 4 and the scaling factor of the vertical reduction filter 204 to be 1, the resolution of the constrained video signal 106 is 480×1080. When the video signal 104 is of 1080 i (1920×1080) and the mode selector 208 sets the scaling factor of the horizontal reduction filter 202 to be 2 and the scaling factor of the vertical reduction filter 204 to be 2, the resolution of the constrained video signal 106 is 960×540. When the video signal 104 is of 1080 i (1920×1080), and the mode selector 208 sets the scaling factor of the horizontal reduction filter to be 4 and the scaling factor of the vertical reduction filter 204 to be 1, the resolution of the constrained video signal 106 is 480×1080. When the video signal 104 is of 720 p (1280×720) and the mode selector 208 sets the scaling factor of the horizontal reduction filter 202 to be 2 and the scaling factor of the vertical reduction filter 204 to be 1, the resolution of the constrained video signal 106 is 640×720.

In some embodiments, the constrained image converter 102 does the vertically scaling sown before doing the horizontally scaling down. For example, in a case that the constrained image converter comprises a vertical reduction filter and a horizontal reduction filter, the vertical reduction filter vertically scales down the video signal outputted from the first multiplexer (104) to generate a vertical-scaled video signal, and then the horizontal reduction filter horizontally scales down the vertical-scaled video signal to generate the constrained video signal 106. In such cases, the constrained image converter may further comprise a mode selector (similar to 208) setting scaling factors of the horizontal and vertical reduction filters.

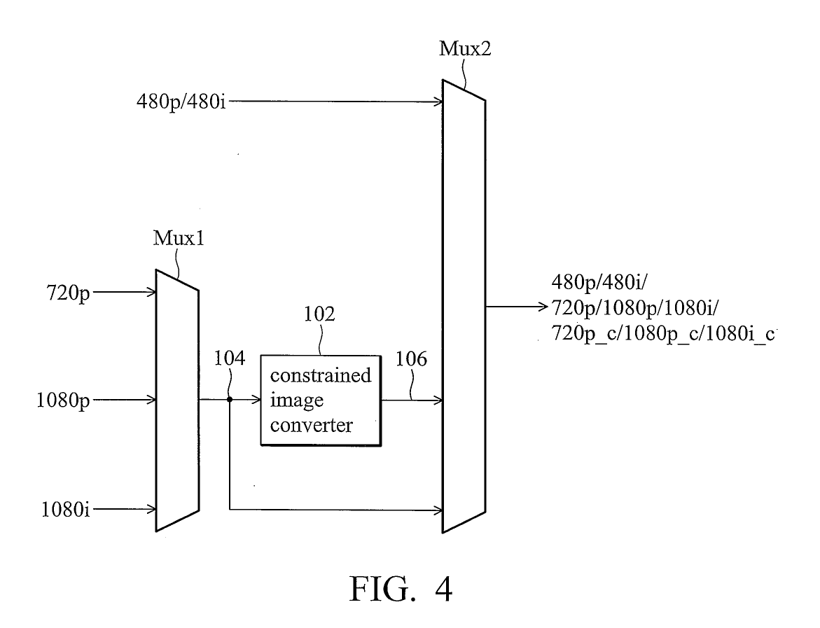

In some embodiments, the second multiplexer Mux2 further receives at least one standard-definition video signal. FIG. 4 shows an embodiment of the invention. In this case, the video format of the standard-definition video signal is of 480 p or 480 i. Therefore, the second multiplexer Mux2 is capable of outputting a video signal of 480 p, 480 i, 720 p, 1080 p or 1080 i, or a constrained video signal generated from a video signal of 720 p, 1080 p or 1080 i.

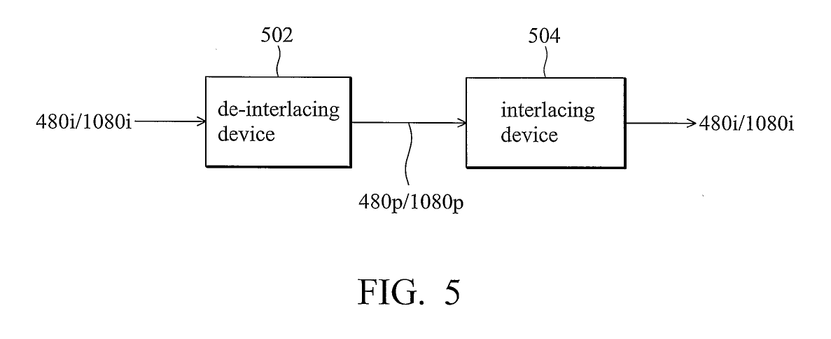

In some embodiments, the invention further comprises a de-interlacing device and an interlacing device. They are used in improving video qualities of video signals of interlaced scanning types. FIG. 5 illustrates the connection between the de-interlacing device and the interlacing device. When a raw video signal inputted to the video processing apparatus is of an interlaced scanning type (such as 1080 i or 480 i), in addition to directly inputting it into the multiplexers Mux1 or Mux2, the invention inputs it into the de-interlacing device 502 to de-interlace the raw video signal from the interlaced scanning type to a progressive scanning type (1080 p or 480 p) and then inputs the deinterlaced video signals to the interlacing device 504 to interlace them from the progressive scanning type to the interlaced scanning type (1080 i or 480 i). The sawtooth of the raw video signal is smoothed by the de-interlacing device 502. The de-interlacing device 502 may de-interlace the raw video signal by field combination de-interlacing, frame extension de-interlacing and so on.

In some embodiments, the de-interlacing device is used in generating video signals of progressive scanning types to be inputted to the multiplexers Mux1 or Mux2. The de-interlacing device de-interlaces a raw video signal of an interlaced scanning type (such as 1080 i or 480 i) to a progressive scanning type (such 1080 p or 480 p) and outputs the deinterlaced video signal to the multiplexers Mux1 or Mux2.

In some embodiments, the interlacing device is used in generating video signals of interlaced scanning types to be inputted to the multiplexers Mux1 or Mux2. The interlacing device interlaces a raw video signal of a progressive scanning type (1080 p or 480 p) to an interlaced scanning type (1080 i or 480 i) and outputs the interlaced video signal to the multiplexers Mux1 or Mux2.

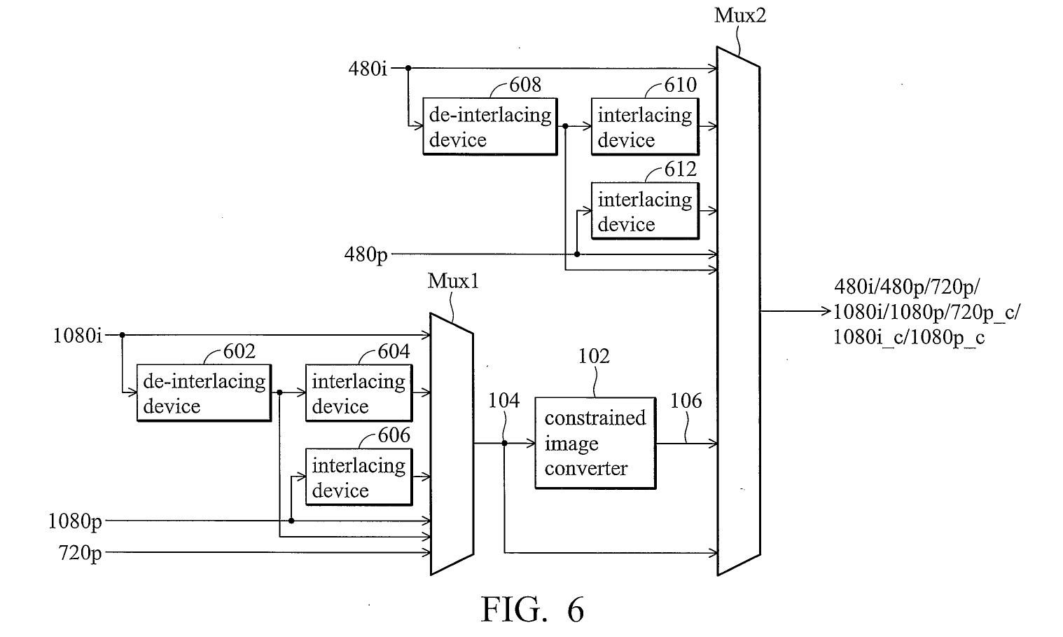

FIG. 6 illustrates a video signal processing apparatus according to an embodiment of the invention. When the video format of the raw video signal is 1080 i, the video signal may be inputted to the first multiplexer Mux1 directly, to the first multiplexer Mux1 after the processing of the de-interlacing device 602 and the interlacing device 604, or to the first multiplexer Mux1 after only the processing of the de-interlacing device 602. When the video format of the raw video signal is 1080 p, the video signal may be inputted to the first multiplexer Mux1 directly or to the first multiplexer Mux1 after processing of the interlacing device 606. When the video format of the raw video signal is 720 p, the video signal may be inputted to the first multiplexer Mux1 directly. When the video format of the raw video signal is 480 i, the video signal may be inputted to the second multiplexer Mux2 directly, to the second multiplexer Mux2 after the processing of the de-interlacing device 608 and the interlacing device 610, or to the second multiplexer Mux2 after the processing of the de-interlacing device 608. When the video format of the raw video signal is 480 p, the video signal may be inputted to the second multiplexer Mux2 directly or to the second multiplexer Mux2 after the processing of the interlacing device 612.

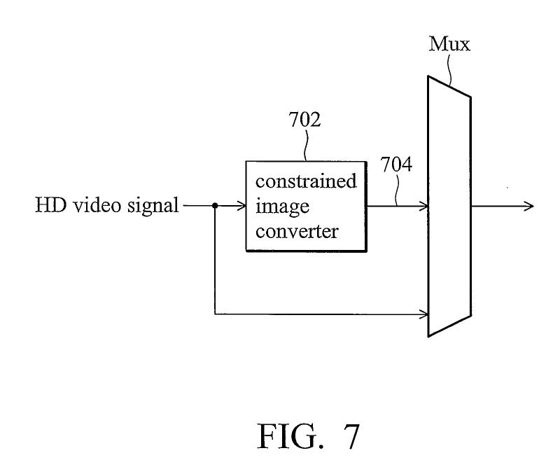

FIG. 7 illustrates another embodiment of the invention. In this embodiment, the video signal processing apparatus comprises a constrained image converter 702 and a multiplexer Mux. The constrained image converter 702 converts a high-definition video signal into a constrained video signal 704. The resolution of the constrained video signal 704 is lower than the resolution of the high-definition video signal and can be displayed on analog displays. The multiplexer Mux receives the high-definition video signal and the constrained video signal 704, and then selectively outputs one of them. In some embodiments, the high-definition video signal is of a progressive scanning type (such as 720 p or 1080 p) or of an interlaced scanning type (such as 1080 i).

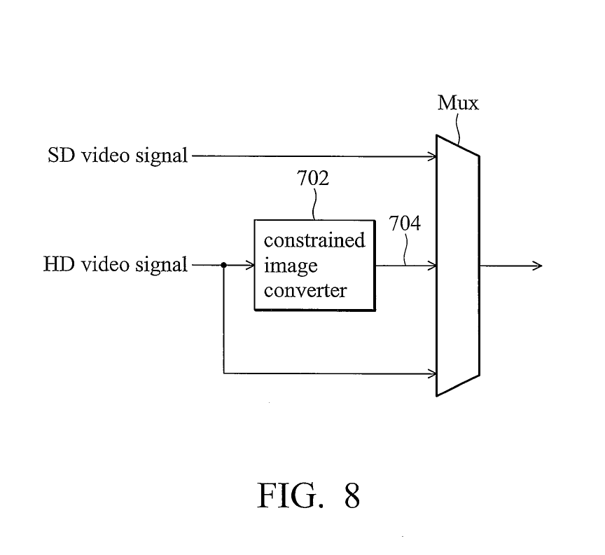

FIG. 8 illustrates another embodiment of the invention. Compared with FIG. 7, the multiplexer Mux shown in FIG. 8 further receives at least one standard-definition video signal. The standard-definition video signal may be of a progressive scanning type, such as 480 p, or of an interlaced scanning type, such as 480 i. The video processing apparatus shown by FIG. 7 and FIG. 8 can provide a video signal in appropriate video format according to the specification of the connected display device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A video signal processing apparatus, comprising:
a first multiplexer, receiving a plurality of first video signals at a plurality of input terminals thereof and selectively outputting one of the received first video signals;
a constrained image converter, converting the first video signal outputted from the first multiplexer into a constrained form to generate a constrained video signal; and
a second multiplexer, receiving the first video signal outputted from the first multiplexer and the constrained video signal at a plurality of input terminals thereof, and selectively outputting one of the received video signals.

2. The video signal processing apparatus as claimed in claim 1, wherein the constrained image converter comprises:
a horizontal reduction filter, horizontally scaling down the first video signal outputted from the first multiplexer to generate a horizontal-scaled video signal; and
a vertical reduction filter, vertically scaling down the horizontal-scaled video signal to generate the constrained video signal.

3. The video signal processing apparatus as claimed in claim 2, wherein the constrained image converter further comprises a mode selector setting scaling factors of the horizontal and vertical reduction filters.

4. The video signal processing apparatus as claimed in claim 1, wherein the constrained image converter comprises:
a vertical reduction filter, vertically scaling down the first video signal outputted from the first multiplexer to generate a vertical-scaled video signal; and
a horizontal reduction filter, horizontally scaling down the vertical-scaled video signal to generate the constrained video signal.

5. The video signal processing apparatus as claimed in claim 4, wherein the constrained image converter further comprises a mode selector setting scaling factors of the horizontal and vertical reduction filters.

6. The video signal processing apparatus as claimed in claim 1, wherein the video formats of the first video signals received by the first multiplexer are 720 p, 1080 p or 1080 i.

7. The video signal processing apparatus as claimed in claim 1, wherein the second multiplexer further receives at least one of a plurality of second video signals.

8. The video signal processing apparatus as claimed in claim 7, wherein the video format of the second video signals is 480 p or 480 i.

9. The video signal processing apparatus as claimed in claim 1, wherein the second multiplexer further directly receives at least one of the first video signals.

10. The video signal processing apparatus as claimed in claim 9, wherein the video formats of the first video signals received by the second multiplexer are 720 p, 1080 p or 1080 i.

11. The video signal processing apparatus as claimed in claim 1, further comprising a de-interlacing device de-interlacing a raw video signal of an interlaced scanning type to a progressive scanning type and having an output terminal coupling to one of the input terminals of the first multiplexer.

12. The video signal processing apparatus as claimed in claim 11, wherein the video format of the raw video signal is 1080 i.

13. The video signal processing apparatus as claimed in claim 12, further comprising an interlacing device coupled to the output terminal of the de-interlacing device, interlacing the video signal outputted therefrom to the interlaced scanning type, and having an output terminal coupling to one of the input terminals of the first multiplexer.

14. The video signal processing apparatus as claimed in claim 1, further comprising an interlacing device, interlacing a raw video signal of a progressive scanning type to an interlaced scanning type and having an output terminal coupling to one of the input terminals of the first multiplexer.

15. The video signal processing apparatus as claimed in claim 14, wherein the video format of the raw video signal is 1080 p.

16. The video signal processing apparatus as claimed in claim 1, further comprising a de-interlacing device, de-interlacing a raw video signal of an interlaced scanning type to a progressive scanning type and having an output terminal coupling to one of the input terminals of the second multiplexer.

17. The video signal processing apparatus as claimed in claim 16, wherein the video format of the raw video signal is 480 i.

18. The video signal processing apparatus as claimed in claim 16, further comprising an interlacing device coupled to the output terminal of the de-interlacing device, interlacing the video signal outputted therefrom to the interlaced scanning type, and having an output terminal coupling to one of the input terminals of the second multiplexer.

19. The video signal processing apparatus as claimed in claim 1, further comprising an interlacing device, interlacing a raw video signal of a progressive scanning type to an interlaced scanning type and having an output terminal coupling to one of the input terminals of the second multiplexer.

20. The video signal processing apparatus as claimed in claim 19, wherein the video format of the raw video signal is 480 p.

21. A video signal processing apparatus, comprising:
a constrained image converter, converting a high-definition video signal into a constrained video signal; and
a multiplexer, receiving the high-definition video signal and the constrained video signal, and selectively outputting one of the received video signals.

22. The video signal processing apparatus as claimed in claim 21, wherein the multiplexer further receives at least one standard-definition video signal.

23. The video signal processing apparatus as claimed in claim 21, wherein the constrained image converter comprises:
a horizontal reduction filter, horizontally scaling down the high-definition video signal to generate a horizontal-scaled video signal; and
a vertical reduction filter, vertically scaling down the horizontal-scaled video signal to generate the constrained video signal.

24. The video signal processing apparatus as claimed in claim 23, wherein the constrained image converter further comprises a mode selector setting scaling factors of the horizontal and vertical reduction filters.

25. The video signal processing apparatus as claimed in claim 21, wherein the video formats of the high-definition video signal is 720 p, 1080 p or 1080 i.
